(19) United States
(12) Patent Application Publication
(10) Pub. No.: US 2025/0148354 A1
(43) Pub. Date: May 8, 2025

(54) SENSITIVE ATTRIBUTE DRIVEN PREDICTIVE MODELING

(71) Applicants: INTERNATIONAL BUSINESS MACHINES CORPORATION, ARMONK, NY (US); MASSACHUSETTS INSTITUTE OF TECHNOLOGY, CAMBRIDGE, MA (US)

(72) Inventors: Abhin Shah, Boston, MA (US); Maohao Shen, Cambridge, MA (US); Jongha Ryu, Cambridge, MA (US); Subhro Das, Cambridge, MA (US); Prasanna Sattigeri, Acton, MA (US); Yuheng Bu, Philadelphia, PA (US); Gregory Wornell, Wellesley, MA (US)

(21) Appl. No.: 18/503,166

(22) Filed: Nov. 6, 2023

(51) Int. Cl. G06N 20/00

(52) U.S. Cl. CPC G06N 20/00

(57) ABSTRACT

A computer-implemented method and system for generating a predictive model include a computation engine learning a predictive model having missing or crippled data. A processor applies a formulated problem of missing or crippled data based learning to the predictive model. The computation engine reduces one or more tasks associated with the predictive model to a quadratically constrained quadratic problem (QCQP). The computation engine characterizes one or more solutions associated with the QCQP, where each of the one or more solutions is a loss function value.

### STATEMENT REGARDING PRIOR DISCLOSURES BY THE INVENTOR OR A JOINT INVENTOR

Shah et al., “Group Fairness with Uncertainty in Sensitive Attributes,” Feb. 16, 2023, available at https://arxiv.org/pdf/2302.08077v1.pdf and Shah et al., “Group Fairness with Uncertainty in Sensitive Attributes,” Jun. 7, 2023, available at https://arxiv.org/pdf/2302.08077.pdf.

### BACKGROUND

### Technical Field

The present disclosure generally relates to methods and systems for automated predictive modeling, and more particularly, to methods and systems for generating a sensitive attribute driven computer predictive model.

### Description of the Related Art

Accounting for sensitive attributes in predictive modeling, whether in classification or regression tasks, is crucial to avoid discriminatory decisions against marginalized groups. Although various problem formulations exist for accounting for sensitive attributes in model training, a widely adopted approach is to formulate an optimization problem that improves (e.g., maximizes) the model's predictive power while satisfying a group sensitive attribute constraint. The notion of group sensitive attribute inclusion stipulates a certain (e.g., conditional) independence consideration involving the model prediction and the sensitive attribute. The goal is to then substantially reduce (e.g., minimize) the prediction loss while ensuring that the sensitive attribute inclusion loss, which measures the degree of group sensitive attribute inclusion, i.e., the degree of violation of the (e.g., conditional) independence consideration, is less than a pre-defined tolerance level ϵ, i.e.,

min Prediction Loss s.t. Sensitive Attribute Inclusion Loss≤ϵ. (1)

Typically, it is assumed that true sensitive attributes are available for every sample in training, but in reality, labeled sensitive attributes are often missing or noisy. For instance, labeling sensitive attributes may involve additional annotation of existing datasets for which such labels were not originally collected. Even if available, the sensitive attribute information can be uncertain due to various reasons, such as noisy or unreliable responses from survey participants due to fear of disclosure or discrimination. Moreover, privacy and legal regulations often limit the use of labeled sensitive attributes, such as race or gender, which are protected by laws such as the EU's General Data Protection Regulation or California's Consumer Privacy Act. In such cases, privatized sensitive attributes, which are obtained by adding noise, may be a limited available option. In such scenarios, estimating the sensitive attribute inclusion loss in Equation 1 using uncertain sensitive attributes, as if correct, can lead to a model that does not accurately capture target sensitive attribute inclusion.

### SUMMARY

According to an embodiment of the present disclosure, a computer-implemented method for generating a predictive model includes a computation engine and a processor. The method includes learning, by the computation engine, a predictive model having missing or crippled data. The processor then applies a formulated problem of missing or crippled data based learning to the predictive model. Once the hardware processor applies the formulated problem of sensitive attribute based learning, the computation engine then reduces one or more tasks associated with the predictive model to a quadratically constrained quadratic problem (QCQP). The computation engine then characterizes one or more solutions associated with the QCQP, where each of the one or more solutions is a loss function value. The method is advantageous in that the predictive models are capable of following strict constraints without any performance loss, leading to more accurate and less biased predictive models.

In one embodiment, which can be combined with the previous embodiment, the missing or crippled data is related to one or more sensitive attributes.

In another embodiment, which can be combined with one or more previous embodiments, the formulated problem is based on an independence of sensitive attribute criterion. By virtue of this feature, a predictive model can achieve a target level of sensitive attribute inclusion despite uncertainty in sensitive attributes.

In another embodiment, which can be combined with one or more previous embodiments, each of the one or more tasks comprise: a classification task or a regression task. By virtue of this feature, a more generally applicable predictive model is provided.

In another embodiment, which can be combined with one or more previous embodiments, the method further includes, in response to uncertainty from a limited amount of labeled data, identifying a contribution of each of the one or more solutions towards an improved (e.g., optimal) performance of the QCQP achieved with unlimited access to labeled sensitive attributes. By virtue of this feature, a more accurate and less biased predictive model is provided.

In another embodiment, which can be combined with one or more previous embodiments, the identifying further includes identifying non-trivial regimes where uncertainty incurs no performance loss associated with the predictive model and embodies a strict sensitive attribute inclusion.

In another embodiment, which can be combined with one or more previous embodiments, a generic bootstrap-based algorithm is utilized by the predictive model for non-Gaussian data. This may have the technical effect of reducing computing resources used by one or more components within the system.

According to an embodiment of the present disclosure, a computer program product for generating a predictive model is provided. The computer program product includes a computer readable storage medium embodying program instructions executable by a processor to cause the processor to perform a plurality of steps. A computation engine learns a predictive model having missing or crippled data. The processor then applies a formulated problem of missing or crippled data based learning to the predictive model. Once the processor applies the formulated problem of sensitive attribute based learning, the computation engine then reduces one or more tasks associated with the predictive model to a quadratically constrained quadratic problem (QCQP). The computation engine then characterizes one or more solutions associated with the QCQP, where each of the one or more solutions is a loss function value. The computer program product is advantageous in that the predictive models are capable of following strict constraints without any performance loss, leading to more accurate and less biased predictive models.

In one embodiment, which can be combined with the previous embodiment, the missing or crippled data is related to one or more sensitive attributes.

In another embodiment, which can be combined with one or more previous embodiments, the formulated problem is based on an independence of sensitive attribute criterion. By virtue of this feature, a predictive model can achieve a target level of sensitive attribute inclusion despite uncertainty in sensitive attributes.

In another embodiment, which can be combined with one or more previous embodiments, each of the one or more tasks comprise: a classification task or a regression task. By virtue of this feature, a more generally applicable predictive model is provided.

In another embodiment, which can be combined with one or more previous embodiments, the computer program product further includes, in response to uncertainty from a limited amount of labeled data, identifying a contribution of each of the one or more solutions towards an improved (e.g., optimal) performance of the QCQP achieved with unlimited access to labeled sensitive attributes. By virtue of this feature, a more accurate and less biased predictive model is provided.

In another embodiment, which can be combined with one or more previous embodiments, the identifying further includes identifying non-trivial regimes where uncertainty incurs no performance loss associated with the predictive model and embodies a strict sensitive attribute inclusion.

According to an embodiment of the present disclosure, a computing system is provided. There is a processor and a computer-readable storage device coupled to the processor. A computation engine is coupled to the processor. Program instructions are stored on the non-transitory computer-readable storage device for execution by the processor via a memory.

According to an embodiment of the present disclosure, a computing system, in conjunction with program instructions, is configured to perform a predictive model generating method. The computation engine learns a predictive model having missing or crippled data. The processor then applies a formulated problem of missing or crippled data based learning to the predictive model. Once the processor applies the formulated problem of sensitive attribute based learning, the computation engine then reduces one or more tasks associated with the predictive model to a quadratically constrained quadratic problem (QCQP). The computation engine then characterizes one or more solutions associated with the QCQP, where each of the one or more solutions is a loss function value. The computing system is advantageous in that the predictive models are capable of following strict constraints without any performance loss, leading to more accurate and less biased predictive models.

In one embodiment, which can be combined with the previous embodiment, the missing or crippled data is related to one or more sensitive attributes.

In another embodiment, which can be combined with one or more previous embodiments, the formulated problem is based on an independence of sensitive attribute criterion. By virtue of this feature, a predictive model can achieve a target level of sensitive attribute inclusion despite uncertainty in sensitive attributes.

In another embodiment, which can be combined with one or more previous embodiments, each of the one or more tasks comprise: a classification task or a regression task. By virtue of this feature, a more generally applicable predictive model is provided.

In another embodiment, which can be combined with one or more previous embodiments, the system further includes, in response to uncertainty from a limited amount of labeled data, identifying a contribution of each of the one or more solutions towards an improved (e.g., optimal) performance of the QCQP achieved with unlimited access to labeled sensitive attributes. By virtue of this feature, a more accurate and less biased predictive model is provided.

In another embodiment, which can be combined with one or more previous embodiments, the identifying further includes identifying non-trivial regimes where uncertainty incurs no performance loss associated with the predictive model and embodies a strict sensitive attribute inclusion.

In another embodiment, which can be combined with one or more previous embodiments, a generic bootstrap-based algorithm is utilized by the predictive model for non-Gaussian data. This may have the technical effect of reducing computing resources used by one or more components within the system.

The techniques described herein may be implemented in a number of ways. Example implementations are provided below with reference to the following figures.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 is a functional block diagram illustration of a computing environment that can communicate with various networked components, consistent with an illustrative embodiment.

FIG. 2 is a diagram of an exemplary graph of error rate versus constraint loss for an Adult dataset, consistent with an illustrative embodiment.

FIG. 3A is a table of an exemplary dataset including a limited sensitive attribute, consistent with an illustrative embodiment.

FIG. 3B is a table of an exemplary dataset including an unreliable sensitive attribute, consistent with an illustrative embodiment.

FIG. 4 presents a computing system for generating a sensitive attribute driven predictive model, consistent with an illustrative embodiment.

FIG. 5A is a diagram illustrating an exemplary methodology for imposing S additional constraints to an optimization problem for a machine learning model, consistent with an illustrative embodiment.

FIG. 5B is a diagram illustrating exemplary methodologies for comparing sensitive attribute inclusion loss in a dataset, consistent with an illustrative embodiment.

FIG. 6A is a diagram illustrating an exemplary methodology for constructing an uncertainty set around a sensitive attribute inclusion loss, consistent with an illustrative embodiment.

FIG. 6B is a simple block diagram illustrating the exemplary method of FIG. 6A, consistent with an illustrative embodiment.

FIGS. 7A and 7B are diagrams of exemplary graphs of violations of a true sensitive attribute constraint gathered for separate covariance matrices, consistent with an illustrative embodiment.

FIGS. 8A and 8B are diagrams of exemplary graphs of average means squared error (MSE) gathered for separate covariance matrices, consistent with an illustrative embodiment.

FIGS. 9A and 9B are diagrams of exemplary histograms of a sensitive attribute inclusion value gathered for separate covariance matrices, consistent with an illustrative embodiment.

FIG. 10A is a diagram of an exemplary table presenting an overview of multiple datasets, consistent with an illustrative embodiment.

FIGS. 10B and 10C are diagrams of exemplary graphs of error rate for a model trained with an Adult dataset, consistent with an illustrative embodiment.

FIGS. 10D and 10E are diagrams of exemplary graphs of means squared error for a model trained with a Communities and Crime dataset, consistent with an illustrative embodiment.

FIGS. 10F and 10G are diagrams of exemplary graphs of means squared error for a model trained with an Insurance dataset, consistent with an illustrative embodiment.

FIGS. 11A, 11B, and 11C are diagrams of exemplary graphs of error rate and means squared error for models trained with datasets of FIG. 10A, consistent with an illustrative embodiment.

FIG. 12 is a flowchart for a computer-implemented method for generating a sensitive attribute driven predictive model, consistent with an illustrative embodiment.

### DETAILED DESCRIPTION

### Overview

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Various metrics and criteria have been proposed to ensure group sensitive attribute inclusion in machine learning, but many of these criteria are mutually exclusive in non-trivial cases. For example, the independence and the separation criteria cannot both be satisfied simultaneously. Different approaches exist to enforce these criteria, mainly falling into one of three categories: (a) pre-processing methods, (b) post-processing methods, and (c) in-processing methods. In relation to the disclosed methods and systems, independence and separation are considered using an in-processing approach, where the objective function accounts for both accuracy and fairness.

Literature on sensitive attribute inclusion in the absence of true sensitive attributes can be broadly categorized into the following three groups: (A.) perturbed sensitive attributes, (B.) proxy variables, and (C.) no sensitive attributes.

In relation to perturbed sensitive attributes, several approaches have been proposed to handle perturbations in sensitive attributes. For example, in-processing methods for fair classification have been developed to deal with noisy group labels. Other examples have investigated the performance of a post-processing algorithm with noisy sensitive labels. Additional examples have explored achieving group constraints with adversarially perturbed and differentially private data, respectively.

In relation to proxy variables, methods have been proposed to achieve group sensitive attribute inclusion when proxy variables are available as substitutes for the sensitive attribute (e.g., zip code as a proxy of race). However, the effectiveness of these methods may be reduced if the correlation between the sensitive attribute and the proxy variables is weak. Another example proposed a semi-supervised learning approach to generate proxy pseudo-labels for partially observed sensitive attributes. While these proxy-based methods can be useful, they risk perpetuating biases.

In relation to no sensitive attributes, methods have been proposed to achieve sensitive attribute inclusion without relying on a labeled sensitive attribute and utilizing distributionally robust optimization to improve the performance of the worst-case risk for all distributions close to the empirical distribution. They aim to achieve Rawlsian max-min sensitive attribute inclusion, but their notion of sensitive attribute inclusion is not defined by the population distribution, which sets it apart from the disclosed group sensitive attribute inclusion. Additionally, it is not straightforward to combine the above presented methods with existing sensitive attribute inclusive training methods, while the disclosed methods can be generally applied to any sensitive attribute inclusive training method.

Additional methods focus on achieving strict group sensitive attribute inclusion given uncertain sensitive attributes, however, the additional methods focus on classification problems with discrete sensitive attributes. In contrast, the disclosed methods are widely applicable, including both regression and classification, as well as both discrete and continuous sensitive attributes.

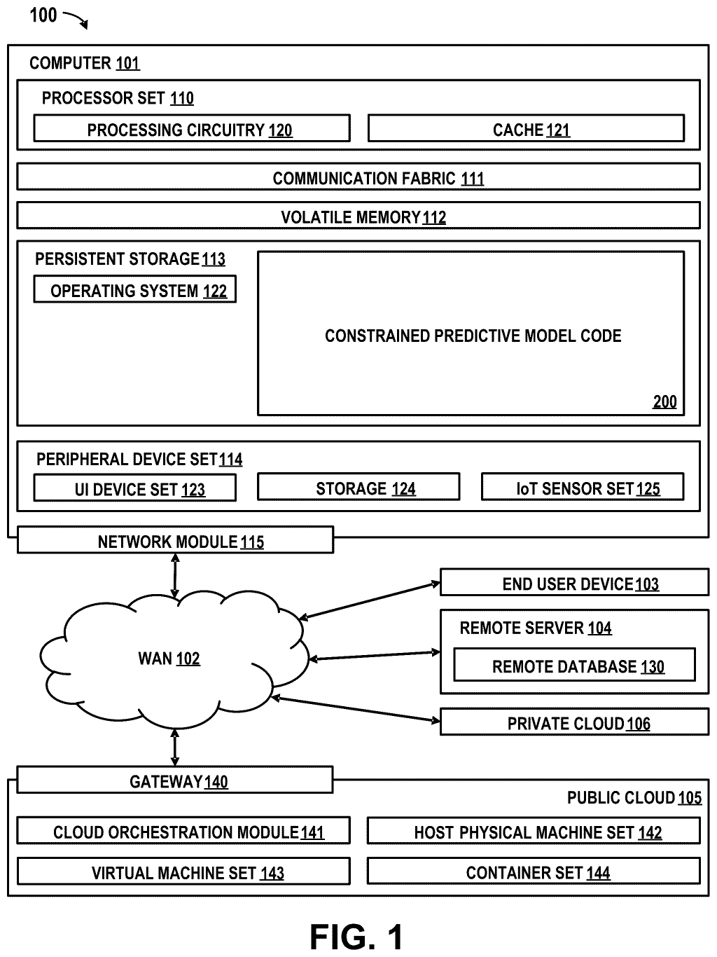

FIG. 1 is a functional block diagram illustration of a computing environment 100 that can communicate with various networked components, such as the cloud, a policy data source, etc. In particular, FIG. 1 illustrates a computing environment 100, as may be used to implement a component, such as, for example, a computation engine 410 and a processor 420.

Computing environment 100 includes an example of an environment for the execution of at least some of the computer code involved in performing the inventive methods, such as constrained predictive model code at block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The present disclosure generally relates to computer-implemented methods for generating predictive models. By virtue of the concepts discussed herein, application of a missing or crippled data based learning formulated problem to a predictive model and predictive model task reduction are utilized to generate predictive models without any performance loss.

### Example Architecture

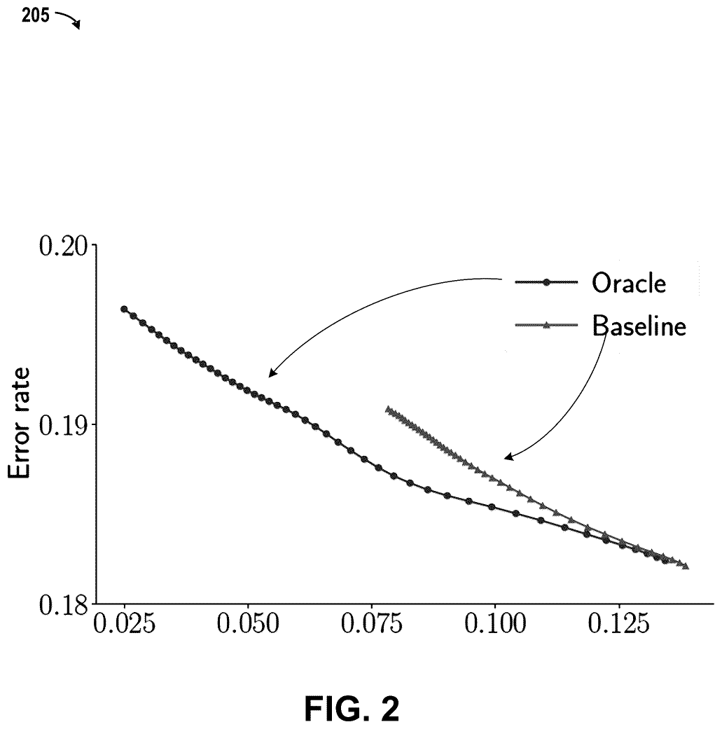

Reference is now made to FIG. 2, which is a diagram of an exemplary graph 205 of error rate versus sensitive attribute inclusion loss for an Adult dataset, consistent with an illustrative embodiment. As shown, FIG. 2 shows a trade-off between prediction (measured by error rate) and sensitive attribute inclusion (measured as violation of independence between predictions and sensitive attributes) obtained by varying ϵ in Equation 1 for adult data. The Oracle methodology has access to correct sensitive attribute values sans crippled and/or missing data (denoted by D^{oracle}), enforces the sensitive attribute inclusion constraint: Sensitive Attribute Inclusion Loss (D^{oracle})≤ϵ, and covers a wide range of sensitive attribute inclusion levels. In contrast, the baseline (orange) has access to a random <1% of the sensitive attributes (denoted by D^{uncertain}) and enforces the sensitive attribute inclusion constraint: Sensitive Attribute Inclusion Loss (D^{uncertain})≤ϵ, but is unable to achieve sensitive attribute inclusion below a threshold, i.e., the baseline provides less control over attainable sensitive attribute inclusion compared to the Oracle methodology. As a result, for high-stakes applications where violating a sensitive attribute inclusion threshold incurs a significant cost, systems and methods that can learn sensitive attribute inclusion models despite uncertainty in sensitive attributes are valuable.

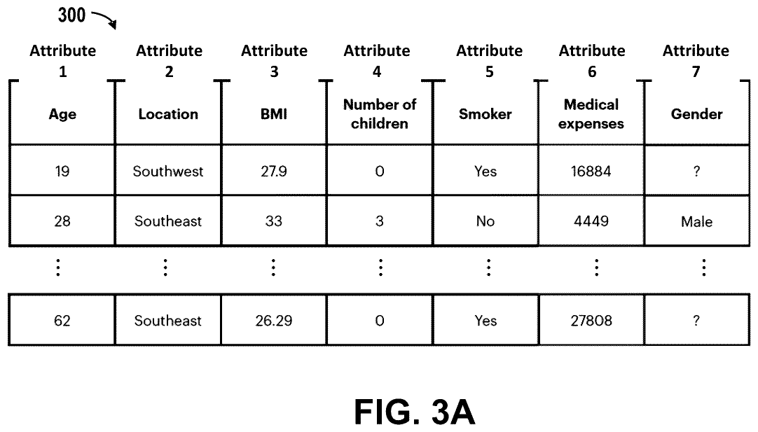

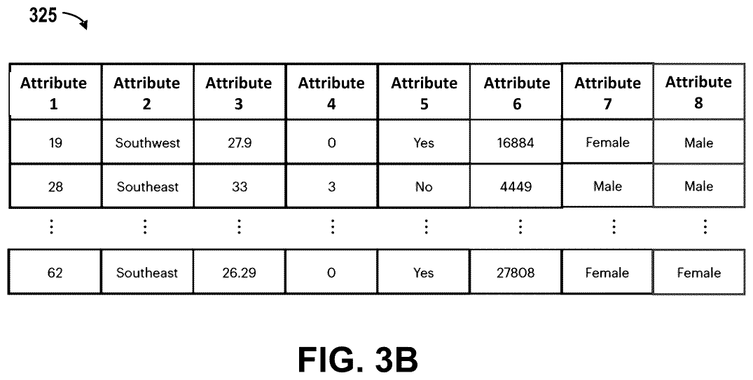

Reference is now made to FIG. 3A, which is a table 300 of an exemplary dataset including a limited sensitive attribute, consistent with an illustrative embodiment. In regards to FIG. 3A, in various embodiments, different attributes can be used for the dataset. By way of example only and not by way of limitation, Attribute 1 could be age, Attribute 2 could be location, Attribute 3 could be BMI, Attribute 4 could be number of children, Attribute 5 could be smoker, Attribute 6 could be medical expenses, and Attribute 7 could be gender. As shown, Attribute 7 can be considered a limited sensitive attribute which may be “limited” in regards to the way that the information related to Attribute 7 is collected. As shown in FIG. 3B, a table 350 presents an exemplary dataset including an unreliable sensitive attribute, consistent with an illustrative embodiment. In regards to FIG. 3B, in various embodiments, different attributes can be used for the dataset. By way of example only and not by way of limitation, Attribute 1 could be age, Attribute 2 could be location, Attribute 3 could be BMI, Attribute 4 could be number of children, Attribute 5 could be smoker, Attribute 6 could be medical expenses, Attribute 7 could be gender, and Attribute 8 could be perturbed gender. As presented in table 350, Attribute 8 can be considered an unreliable sensitive attribute that may be “unreliable” based on any of the following: values being given incorrectly when data is gathered or certain data being withheld via laws/regulations.

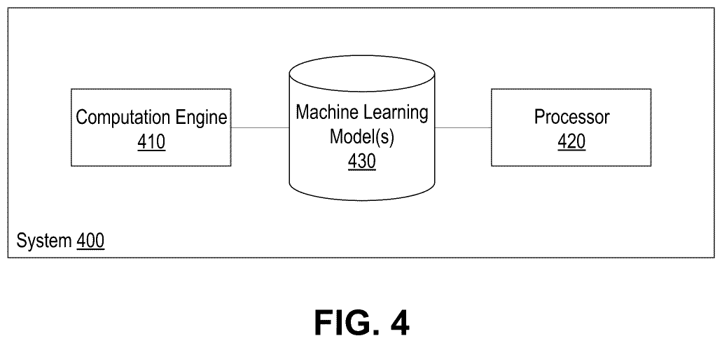

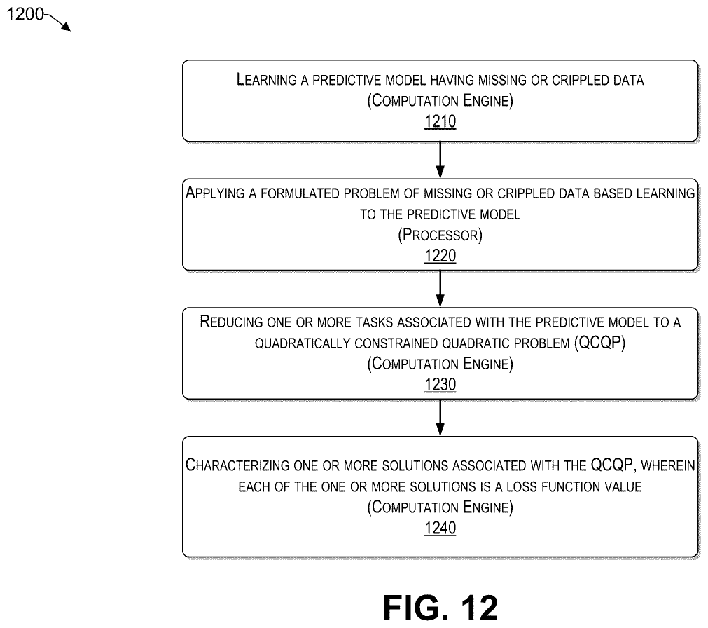

Reference is now made to FIG. 4, which presents a computing system 400 for generating a sensitive attribute driven predictive model, consistent with an illustrative embodiment. As shown, system 400 includes a computation engine 410, a processor 420, and one or more machine learning models 430. Examples of models 430, in embodiments, include classification or regression. Computation engine 410 and processor 420 are adapted to configure, and facilitate training of, machine learning models 430 by performing the process presented in FIG. 12. For example, computation engine 410 enables the following: the learning of a predictive model having at least one uncertain sensitive attribute, the reduction of one or more tasks associated with the predictive model to a quadratically constrained quadratic problem (QCQP), and the characterization of one or more solutions associated with the QCQP (where each of the one or more solutions is a sensitive attribute loss function value). As a further example, processor 420 enables the application of a formulated problem of sensitive attribute based learning to the predictive model. For the purposes of this disclosure, the referenced “predictive models” may originate from machine learning model(s) 430.

Program instructions (sometimes referred to as constrained predictive model code at block 200 of FIG. 1) stored on the non-transitory computer-readable storage device are configured for execution by the processor via a memory (similar to the volatile memory 112 of FIG. 1) coupled to the processor (for example, processor 420). The instructions are configured to render computing system 400 capable of performing a number of operations in a computer-implemented method for generating a sensitive attribute driven predictive model (presented similarly in FIG. 12). The method includes learning, by the computation engine 410, a predictive model having at least one uncertain sensitive attribute. The processor 420 then applies a formulated problem of sensitive attribute based learning to the predictive model. Once the processor 420 applies the formulated problem of sensitive attribute based learning, the computation engine 410 then reduces one or more tasks associated with the predictive model to a quadratically constrained quadratic problem (QCQP). The computation engine 410 then characterizes one or more solutions associated with the QCQP, where each of the one or more solutions is a sensitive attribute loss function value. The computing system 400/method is advantageous in that the predictive models are capable of following strict constraints without any performance loss, leading to more accurate and less biased predictive models.

In one embodiment, the missing or crippled data is related to one or more sensitive attributes.

In one embodiment, the formulated problem is based on an independence of sensitive attribute criterion. By virtue of this feature, a predictive model can achieve a target level of sensitive attribute inclusion despite uncertainty in sensitive attributes.

In one embodiment, each of the one or more tasks comprise: a classification task or a regression task. By virtue of this feature, a more generally applicable predictive model is provided.

In one embodiment, execution of the instructions by the processor configures computing system 400 to additionally perform, in response to uncertainty from a limited amount of labeled data, identifying a contribution of each of the one or more solutions towards an improved (e.g., optimal) performance of the QCQP achieved with unlimited access to labeled sensitive attributes. By virtue of this feature, a more accurate and less biased predictive model is provided.

In one embodiment, the identifying further comprises identifying non-trivial regimes where uncertainty incurs no performance loss associated with the predictive model and embodies a strict sensitive attribute inclusion.

In one embodiment, a generic bootstrap-based algorithm is utilized by the predictive model for non-Gaussian data. This may have the technical effect of reducing computing resources used by one or more components within the system.

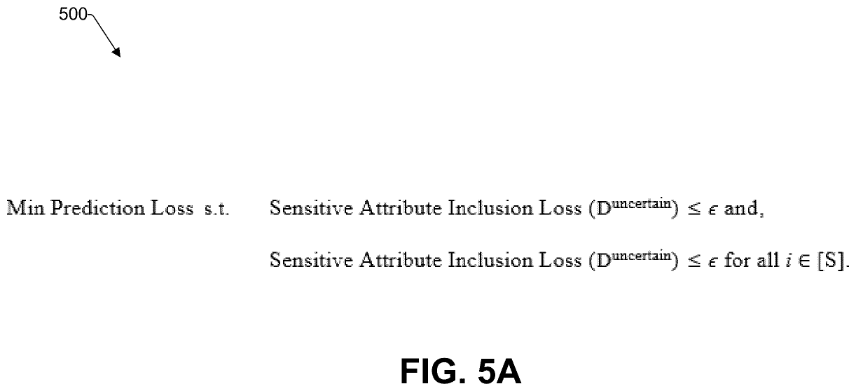

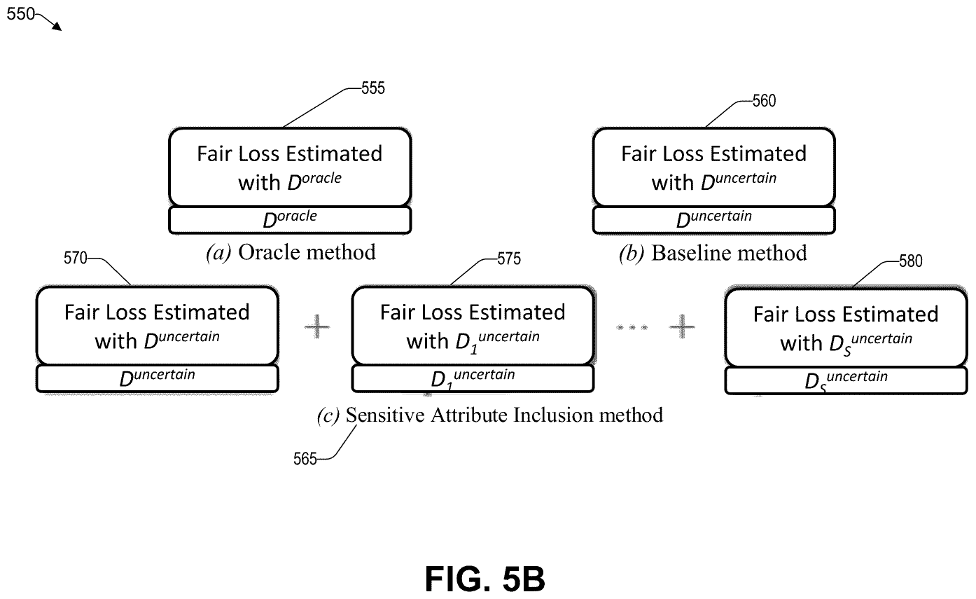

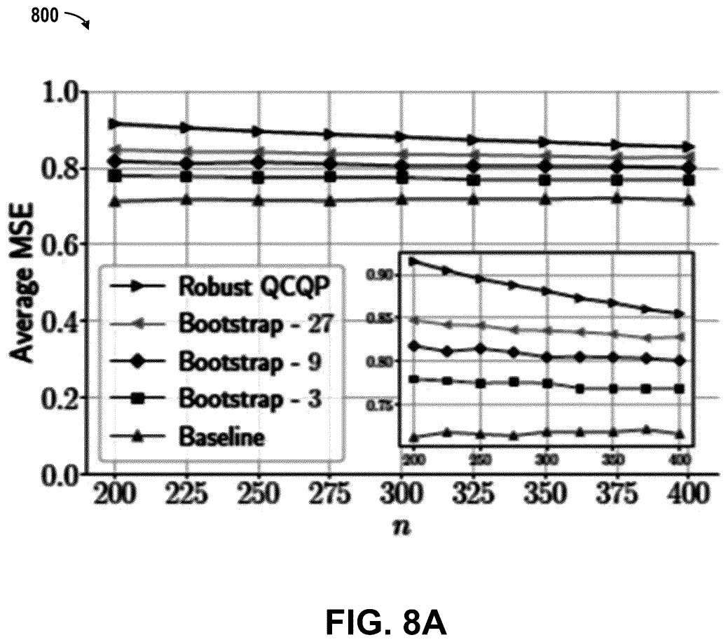

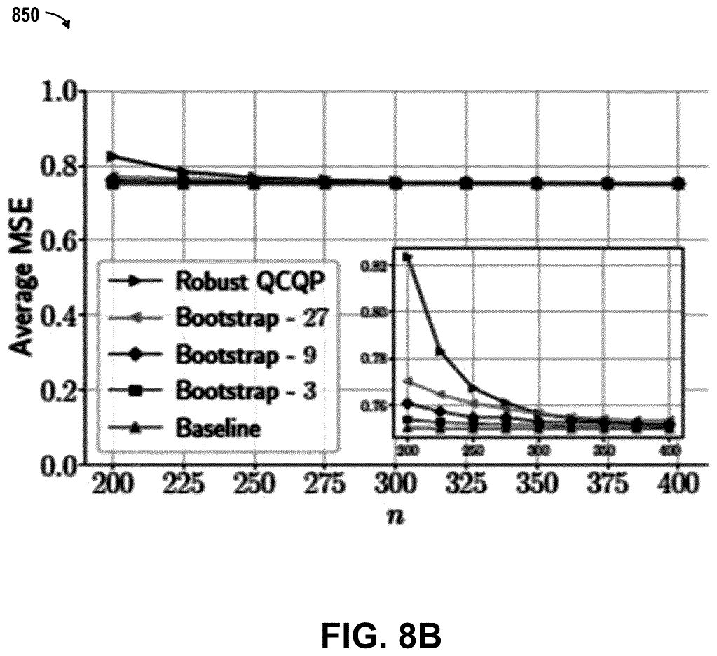

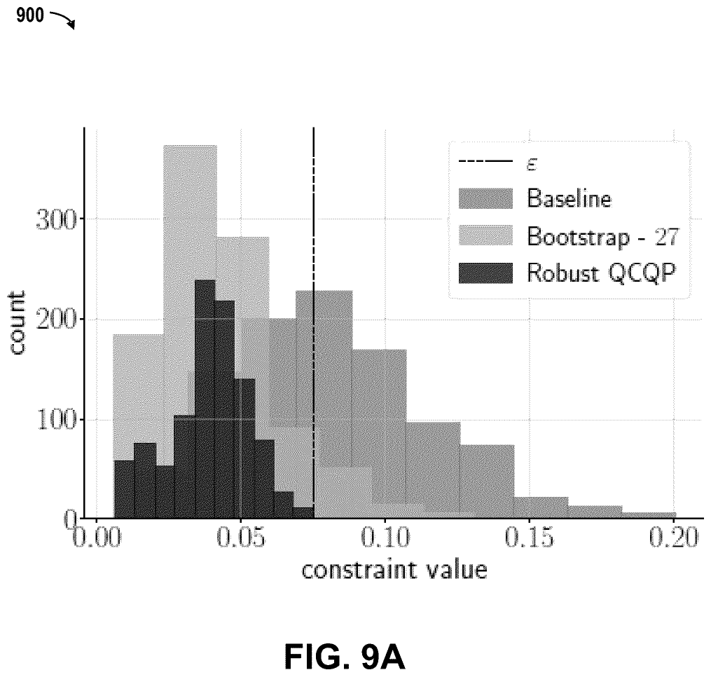

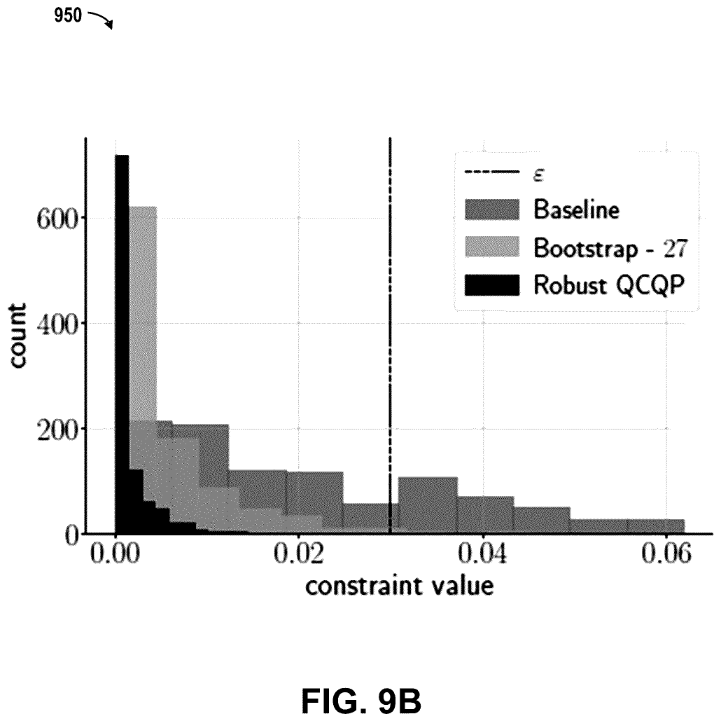

According to an embodiment, a computer program product for generating a sensitive attribute driven predictive model is provided. The computer program product includes a computer readable storage medium embodying program instructions executable by a processor to cause the processor to perform a plurality of steps. These steps may correlate to any process steps/functions relative to any of FIGS. 5-12.

Reference is now made to FIG. 5A, which is a diagram 500 illustrating an exemplary methodology for imposing S additional constraints to an optimization problem for a machine learning model, consistent with an illustrative embodiment. As shown, the algorithm uses a bootstrap approach to impose S additional constraints to the optimization in Equation 1 for some parameter S. For i∈[S], constraint i requires Sensitive Attribute Inclusion Loss(Dᵢ^{uncertain})≤ϵ, where Dᵢ^{uncertain} is a collection of a fixed number of random subsamples of the uncertain sensitive attributes D^{uncertain}.

Reference is now made to FIG. 5B, which is a diagram 550 illustrating exemplary methodologies for comparing sensitive attribute inclusion loss in a dataset, consistent with an illustrative embodiment. As shown, Bootstrap-S 565 (algorithm from FIG. 5A in block form) is contrasted with the Oracle model 555 that constrains the sensitive attribute inclusion loss estimated using true sensitive attributes D^{oracle} and the Baseline method 560 that constrains the sensitive attribute inclusion loss estimated using available uncertain sensitive attributes D^{uncertain} as if they are correct. Bootstrap-S constrains the optimization with additional sensitive attribute inclusion losses estimated using subsamples D^{uncertain} 570,575,580, ∀i∈[S]. In relation to Bootstrap-S 565, analysis of sensitive attribute inclusion learning for Gaussian data with a focus on the independence notion of sensitive attribute inclusion serves as a motivation for Bootstrap-S 565. It is noted that the methodologies found in FIG. 5B take into account uncertainty related to missing sensitive attributes.

A specific instance of Bootstrap-S is then reduced to a quadratically constrained quadratic problem (QCQP) when true sensitive attributes are available. Next, given the uncertainty in the sensitive attributes, the QCQP is robustified to provide a strict constraint/sensitive attribute inclusion and the solution of the QCQP is fully characterized. It is noted that when uncertainty arises due to randomly missing sensitive attributes, in some cases, the robust QCQP can achieve strict sensitive attribute inclusion without any performance loss (referred to as free sensitive attribute inclusion).

### Problem Formulation

In an embodiment, a scenario is presented where x represents d-dimensional input features defined on the alphabet X, while y and e denote a 1-dimensional target and a sensitive attribute defined on the alphabets Y and E, respectively. Sensitive attribute inclusive supervised learning seeks to find a predictor f: X→Y that: (a) accurately estimates the target variable for new input features and (b) avoids discrimination based on the sensitive attribute. To achieve this, (a) a loss function [symbol] : Y×Y→R+, where [symbol] (y, f(x)) measures the disagreement between the target variable and its prediction, and (b) a fairness measure Φ: Y×Y×E→R+, where Φ(y, f(x), e) measures the level of discrimination of f are presented. Given a fairness target ϵ≥0 and a class of predictors F, the goal of fair learning is to find an f∈F that reduces (e.g., minimizes) the expected loss [symbol] , subject to the sensitive attribute inclusion measure Φ being small (for ease of notation, hereon,

$$u {=}^{Δ} f ( x ) ) :$$

$$f * ∈ {arg}_{f ∈ F} min E ℓ ( y , f ( x ) ) s . t . Φ ( y , f ( x ) , e ) \leq ϵ . \qquad ( 2 )$$

The choice of loss function [symbol] depends on the specific alphabet Y. In relation to Bootstrap-S 565, regression and binary classification tasks are the focus, where Y is either R or {0, 1}, respectively. For Y=R, the mean squared error (MSE) loss is used, defined as [symbol] (y, u)=(y−u)². For Y={0, 1}, the log loss is used, defined as [symbol] (y, u)=−y log u−(1−y)log(1−u).

To design a sensitive attribute inclusion measure Φ, it is salient to establish what is meant by a “sensitive attribute inclusive predictor”, i.e., ϵ=0 in Equation 2. Generally, sensitive attribute inclusion is described in terms of statistical independence. Two commonly used fairness criteria may be utilized: independence and separation. The independence criterion, also called demographic parity, demands that u⊥e, meaning that predictions should not reveal any information about sensitive attributes. The separation criterion, also known as equalized odds, requires that u ⊥e|y, indicating that predictions should not disclose any information about sensitive attributes given the knowledge of true target variables.

Achieving substantially improved (e.g., perfect) sensitive attribute inclusion is not feasible when learning a predictor from finite training samples. Instead, in practice, an individual often works with measures of approximate sensitive attribute inclusion. This is performed by choosing ϵ>0 in Equation 2, and then varying ϵ to find a balance between sensitive attribute inclusion and accuracy. As substantially improved (e.g., perfect) sensitive attribute inclusion measures assert that certain random variables should be independent, a natural way to measure approximate sensitive attribute inclusion is to use divergence that measures the degree of independence between these variables. It is noted that χ²-divergence is an effective measure of approximate constraint. Subsequently, in embodiments, χ²-divergence is chosen as a measure of the degree of independence, except in cases where the data is Gaussian, where, in this embodiment, a different analytically convenient divergence (see Para. [0092]) is utilized. For independence, the measure is given by Φ(y, u, e)=χ²(p_{e,u}∥pₑpₑ), where p_{e,u}, pₑ, and pᵤ are marginal distributions of (e, u), e, and u, respectively. Likewise, for separation Φ(y, u, e)=Eₚ[χ² Pe,u|y Pe|y Pe|y], where pe,u|y, pe|y, and pu|y are conditional distributions of (e, u), e, and u given y, respectively.

In various embodiments, N independent and identically distributed (i.i.d.) samples of the tuple (x, y, e) are available, denoted by

$${D}^{( 0 )} {=}^{Δ} {\{ {x}^{( i )} , {y}^{( i )} , {e}^{( i )} \}}_{i ∈ [ N ]} .$$

In the optimization in Equation 2, the objective is estimated using the subset

$${D}^{( p )} {=}^{Δ} {\{ {x}^{( i )} , {y}^{( i )} \}}_{i ∈ [ N ]}$$

while the constraint is estimated using an appropriate subset of D^{(o)} depending on the functional form Φ. These estimates are denoted by E_{D(p)} [symbol] (y, f(x)) and Φ_{D}^{(o)} (v, f(x), e), respectively (for brevity). It is assumed that N is sufficiently large and ignores any errors in these estimates to focus on errors due to uncertainty in sensitive attributes.

When dealing with uncertain sensitive attributes, access to D^{(o)} may not be possible. To account for such uncertainty, access is assumed for D^{(p)} as well as n≤N (potentially noisy) labeled sensitive attributes

$${D}^{( u )} {=}^{Δ} {\{ {x}^{( i )} , {y}^{( i )} , {\hat{e}}^{( i )} \}}_{i ∈ [ n ]} .$$

For i∈[N], if ê⁽ⁱ⁾/=e⁽ⁱ⁾, then sensitive attribute ê⁽ⁱ⁾ is noisy. Further, if n<N, then sensitive attributes {e⁽ⁱ⁾}^{N}ᵢ₌ₙ₊₁ are missing. Then, the goal of sensitive attribute inclusive learning with uncertain sensitive attributes is to solve the optimization in Equation 2 with access to D^{(p)} and D^{(u)}. While this seems to be intuitively appealing, simply computing the constraint in Equation 2 with D^{(u)} may be sub-optimal as discussed previously. In other words, a predictor u satisfying Φ_{D}_{^{(u)}} (y, u, e)≤ϵ may not necessarily satisfy Φ_{D}_{^{(o)}} (y, u, e)≤ϵ. To address this issue and gain some insight, an embodiment is considered where (x, y, e, u) is jointly Gaussian. In this embodiment, the optimization problem in Equation 2 is fully characterized and strict sensitive attribute inclusion is provided despite uncertainty in sensitive attributes. Subsequently, building on this analysis, a general-purpose algorithm is developed.

For the purposes of this disclosure, zero-mean Gaussian variables are considered and it is assumed that the marginal distribution p_{x,y} is known or can be learned from D^{(p)}. The variable u can be thought of as a representation of the features while the predictor can be E[y|u]. Naturally, the loss function [symbol] is chosen to be the mean squared loss as Y=R. At this point, the independence criterion of sensitive attribute inclusion is focused on and the degree of independence between u and e is measured using the notion of D̅-divergence, a second-order approximation of Kullback-Leibler divergence. The D̅-divergence between zero-mean Gaussian random vectors v˜pᵥ=N(0, Σᵥ) and w˜p_{w}=N(0, Σ_{w}), with |∥⋅∥|_{F} denoting the Frobenius norm, is given by:

$${\overline{D} ( {p}_{v} ‖ {p}_{w} ) {=}^{Δ} 1 / 2 ‖ \vert {\sum }_{w}^{- 1 / 2} ( {\sum }_{v} - {\sum }_{w} ) {\sum }_{w}^{- 1 / 2} ‖ \vert}_{F}^{2} .$$

For these choices, the optimization in Equation 2 reduces to learning a Gaussian variable u such that:

$${u}^{*} ∈ {arg}_{u} min {E ( y - E [ y \vert u ] )}^{2} ) s . t . D ( {p}_{e , u} ‖ {p}_{e} {p}_{u} ) \leq ϵ . \qquad ( 3 )$$

Next, Equation 3 is reformulated into a quadratically constrained quadratic program (QCQP) by utilizing the notion of canonical correlation matrices (CCMs). The canonical correlation matrix (CCM) between zero-mean jointly Gaussian random vectors v˜N(0, Σᵥ) and w˜N (0, Σ_{w}) is given by

$${b}_{v w} {=}^{Δ} {\sum }_{vv}^{- 1 / 2} {\sum }_{v w} {\sum }_{ww}^{- 1 / 2} ,$$

where Σ_{vw} is the cross-covariance matrix between v and w. The D̅-divergence is conveniently represented by these CCMs.

Using the information bottleneck principle, the equivalence between Equation 3 and a QCQP that uses CCMs is realized (Theorem 1). The optimization problem in Equation 3 is equivalent to:

$${max}_{a ∈ B ( 0 , 1 )} {〈 a , {b}_{y x} 〉}^{2} s . t . {〈 a , {b}_{e x} 〉}^{2} \leq ε , \qquad ( 4 )$$

where B(0, 1) denotes an [symbol] ₂ ball centered at 0 with radius 1, [symbol] ·,· [symbol] denotes the inner product, and “a” plays the role of bᵤₓ. It is noted that “a” in Equation 4 has the same dimension as x, i.e., d. An optimal solution a* of the QCQP in Equation 4 lies in the subspace spanned by the vectors b_{yx} and bₑₓ. This result shows that any d-dimensional QCQP in Equation 4 can be mapped to a 2-dimensional QCQP (i.e., d=2 suffices for QCQP). Additionally, Theorem 1 demonstrates that considering the uncertainty in the CCM (bₑₓ) is sufficient to capture the uncertainty in sensitive attributes.

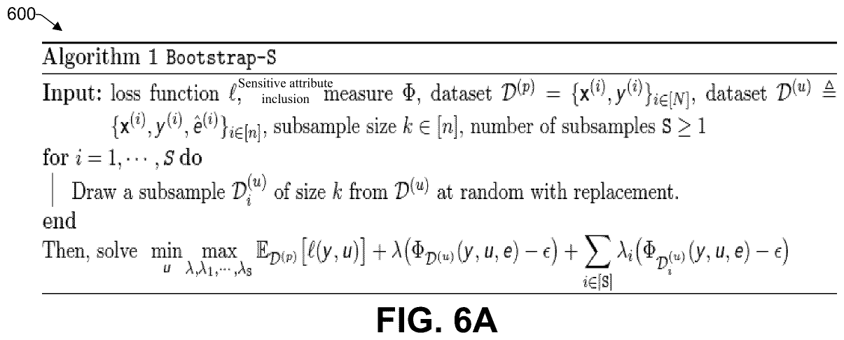

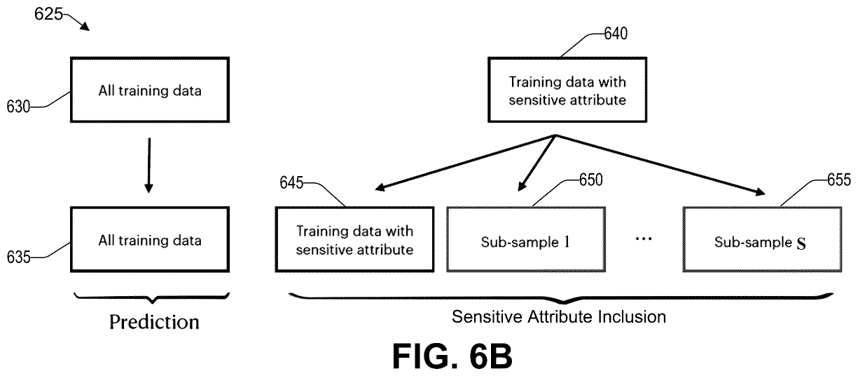

Reference is now made to FIG. 6A, which is a diagram 600 illustrating an exemplary methodology for constructing an uncertainty set around a sensitive attribute inclusion loss, consistent with an illustrative embodiment. In this embodiment, theoretical analysis is leveraged to propose a generic algorithm that handles high-dimensional features and non-Gaussian data while also accounting for uncertainty. Additionally, using a robust QCQP, an uncertainty set is constructed around the estimated canonical correlation matrix \hat{b}ₑₓ by imposing additional constraints. This approach effectively addresses the unknown nature of the true bₑₓ. An additional perspective is to view the robust QCQP as:

$${max}_{a ∈ B ( 0 , 1 )} {〈 a , {b}_{y x} 〉}^{2} s . t . {〈 a , {\hat{b}}_{e x} 〉}^{2} \leq ε and {〈 a , {b}_{ex}^{( i )} 〉}^{2} \leq ε for all i ∈ [ 3 ] ,$$

where the constraint [symbol] a, \hat{b}ₑₓ [symbol] ² ≤ε becomes redundant in the presence of the constraint [symbol] a, b⁽¹⁾ₑₓ [symbol] ²≤ε, and {b⁽ⁱ⁾ₑₓ}_{i∈[3]} can be viewed as multiple estimates of \hat{b}ₑₓ. For general non-Gaussian data, in embodiments, a similar, but non-parametric fashioned, ideal is utilized.

Specifically, given uncertain sensitive attribute data D^{(u)}={x₁(i), y(i), [symbol] }_{i∈[n]}, a sensitive attribute inclusion measure Φ(y, u, e), and a parameter S: S subsets D₁^{(u)}, . . . , D_{S}^{(u)} of some size k∈[n] from D^{(u)} are uniformly drawn at random with replacement. Subsequently, the sensitive attribute inclusion measure is estimated using each of these subsets as well as D^{(u)}, and impose the collection of S constraints {Φ₍ᵤ₎ (y, u, e)≤ϵ}_{i∈[S]} together with the constraint Φ_{D}^{(u)} (y, u, e)≤ϵ. Finally, the following optimization is solved:

$${min}_{u} {E}_{D ( p )} ℓ ( y , u ) s . t {Φ}_{{D}^{( u )}} ( y , u , e ) \leq ϵ and {Φ}_{{D}^{( u )}} {( y}_{i} , u , e ) \leq ϵ for all i ∈ [ S ] . \qquad ( 5 )$$

At a high level, the previously described methodologies, in embodiments, are similar to bootstrap confidence intervals, which allows the construction of a better uncertainty set with a larger number of subsamples S. It is noted that Equation 5 is a constrained optimization problem, which is non-trivial to solve in practice, especially for neural network training. Typically, this problem is addressed by simply adding the sensitive attribute inclusive constraints as regularizers with hyperparameters to control the trade-off during optimization, i.e.: min Prediction Loss+λ×Fairness Loss. However, the performance can be sub-optimal as it depends on the choice of λ. Instead, in this embodiment, the Lagrangian dual of Equation 5 is considered and the resulting objective is optimized over the duality variables, i.e.,

$${min}_{u} {max}_{λ , {λ}_{1} , … , {λ}_{s}} {E}_{D ( p )} [ ℓ ( y , u ) ] + λ ( {Φ}_{{D}^{( u )}} ( y , u , e ) - ϵ ) + \sum {{λ}_{i}}_{i ∈ ⌈ S ⌉} ( {Φ}_{{D}_{i}^{( u )}} ( y , u , e ) - ϵ ) \qquad ( 6 )$$

Reference is now made to FIG. 6B, which is a simple block diagram 625 illustrating the exemplary method of FIG. 6A, consistent with an illustrative embodiment. Bootstrap-S 565 is configured to perform, in embodiments, two tasks: a prediction task and a sensitive attribute inclusion task. As shown, blocks 630 and 635 represent the prediction task. All of the training data, in this embodiment, is used as it is. The sensitive attribute inclusion task, in this embodiment is represented by blocks 640,645,650,655, where pseudo datasets (see blocks 650,655) are created in order to estimate a final dataset. Using this methodology, accuracy can be sacrificed (reduced) in order to improve the inclusion of sensitive attributes (fixed variables) and to improve the performance of the algorithm.

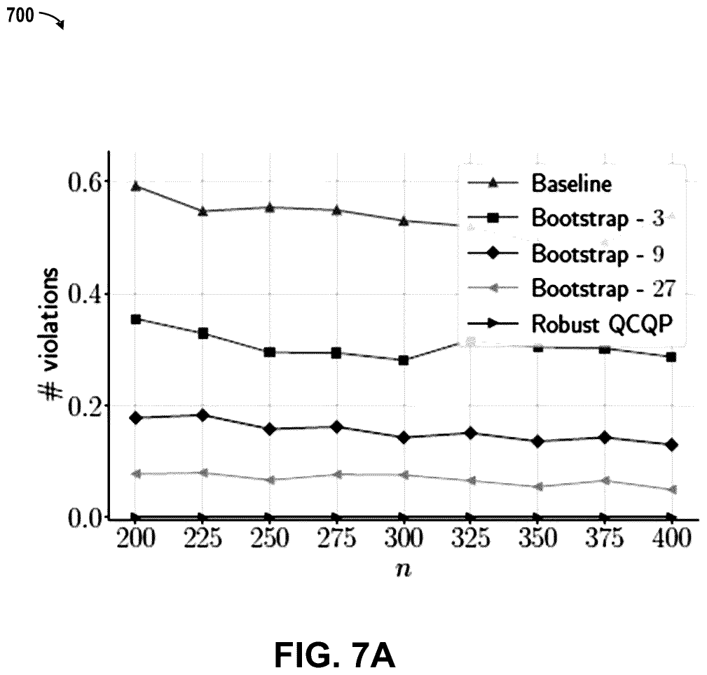

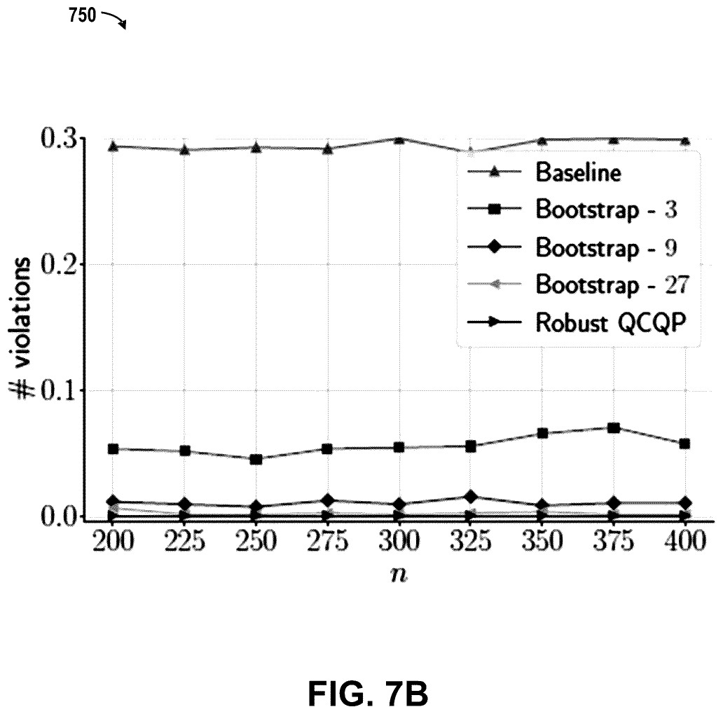

Reference is now made to FIGS. 7A-7B, 8A-8B, and 9A-9B, which are diagrams of exemplary graphs 700,750,800,850 and histograms 900,950 for separate covariance matrices, consistent with an illustrative embodiment. As shown, the performance of robust QCQP, Bootstrap-S 565 with S ϵ {3,9,27}, and Baseline method are compared when d=2 and Σ* varies. Specifically, the fraction of violations of the true constrained constraint [symbol] a, bₑₓ [symbol] ²≤ε vs. n are plotted in FIGS. 6A and 6B, average MSE vs n is plotted in FIGS. 7A and 7B, and histograms of the value of [symbol] a, bₑₓ [symbol] ² are plotted over 1,000 trials for n=250. The synthetic data is generated using two Gaussian distributions with zero mean, d=2, and covariance matrices (a) Σ₂^{gen} and (b) Σ₂^{fair}. The covariances Σ₂^{gen} and Σ₂^{fair}are designed to demonstrate the general behavior (where uncertainty hurts) and the free-constraint behavior (Corollary 1: There exist problem instances of the robust QCQP where the uncertainty incurs no performance loss while achieving a strict sensitive attribute inclusion, without requiring additional labeled sensitive attributes.), respectively. It is noted that results are presented when uncertainty is due to randomly missing sensitive attributes.

The results in FIGS. 7A-7B, 8A-8B, and 9A-9B (averaging over 1000 random trials) show that the robust QCQP provides no sensitive attribute inclusion violations. Additionally, the performance (in terms of average MSE) of robust QCQP monotonically improves as n increases. More importantly, in FIGS. 7B, 8B, and 9B, the robust QCQP does not incur any significant loss in the performance, and therefore demonstrates the free-sensitive attribute inclusion phenomenon of Corollary 1 from n≈350 and higher. It is also observed that Bootstrap-S 565 effectively approximates the performance of the robust QCQP and outperforms the Baseline method 560 in terms of sensitive attribute inclusion violations. As alluded to previously, Bootstrap-S 565 achieves a better sensitive attribute inclusion criterion as the number of subsamples are increased by forming a more accurate uncertainty set.

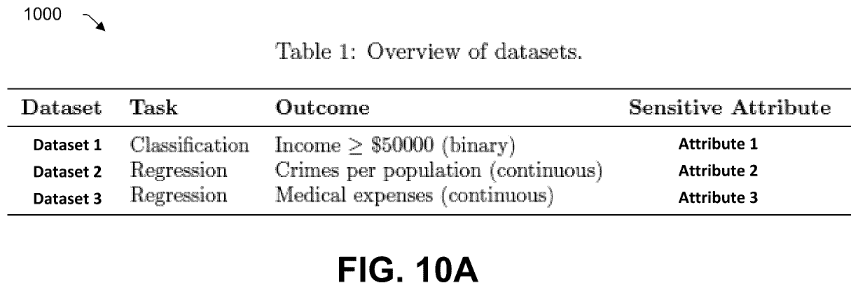

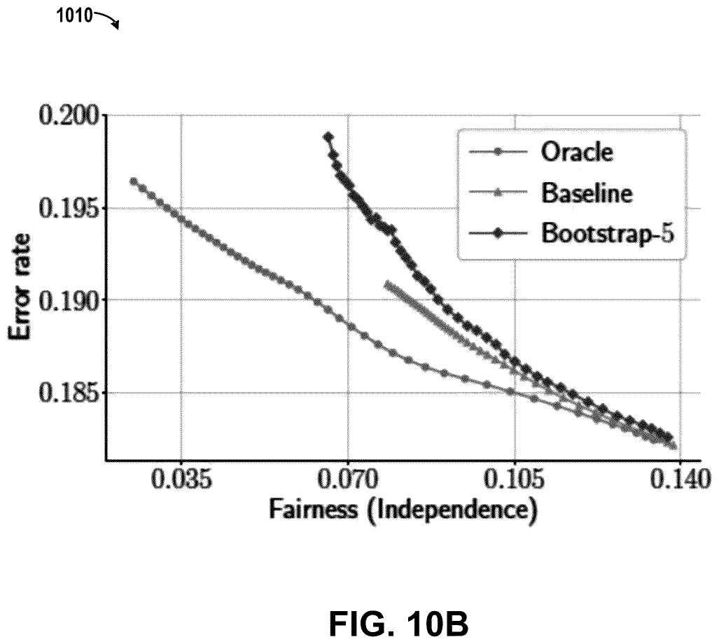

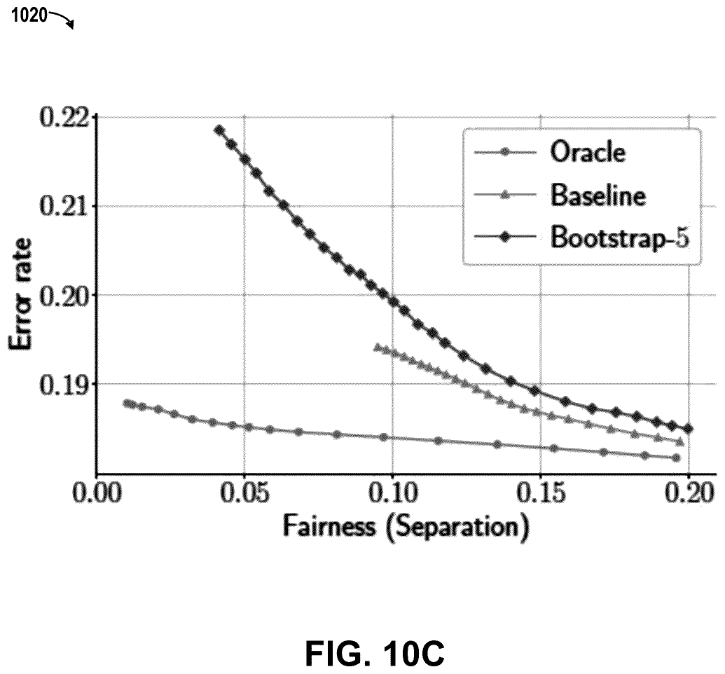

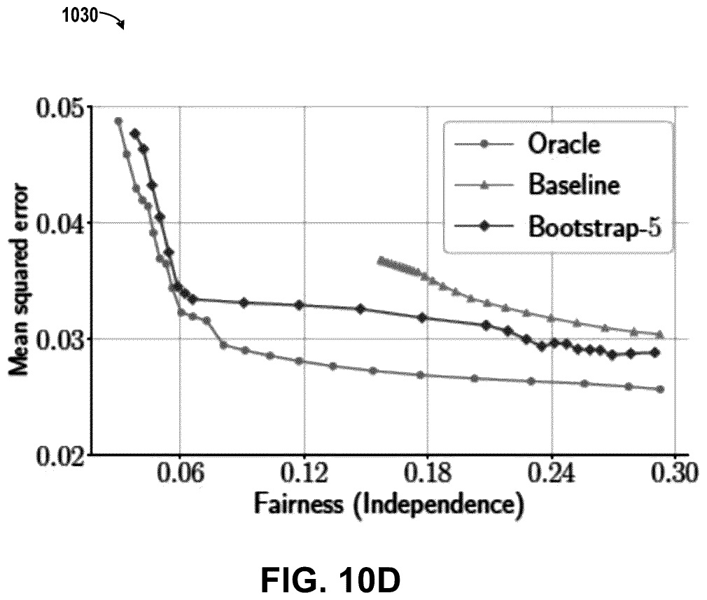

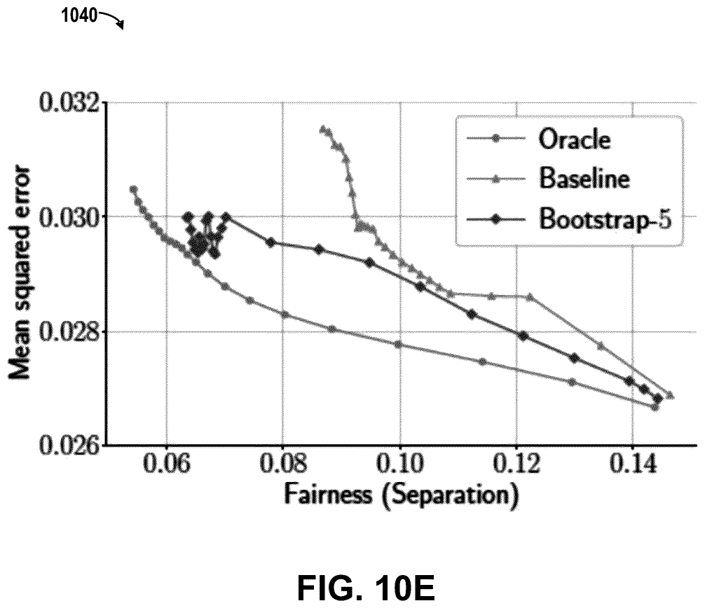

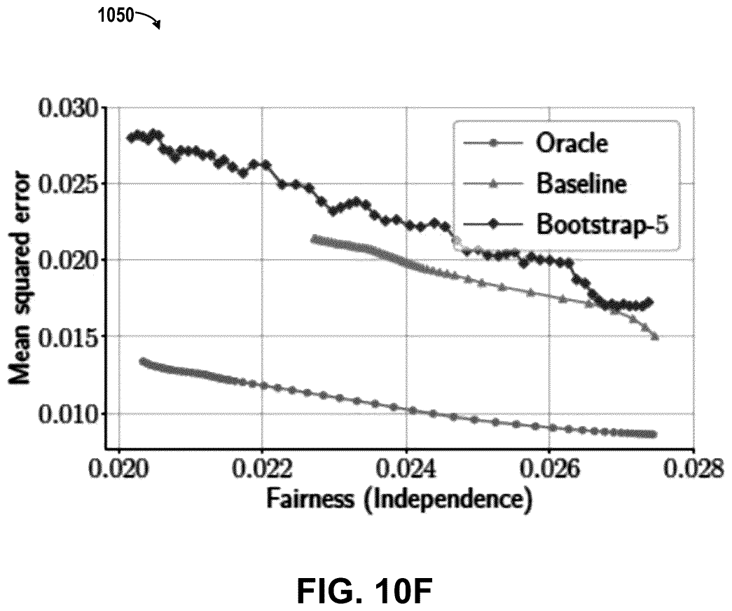

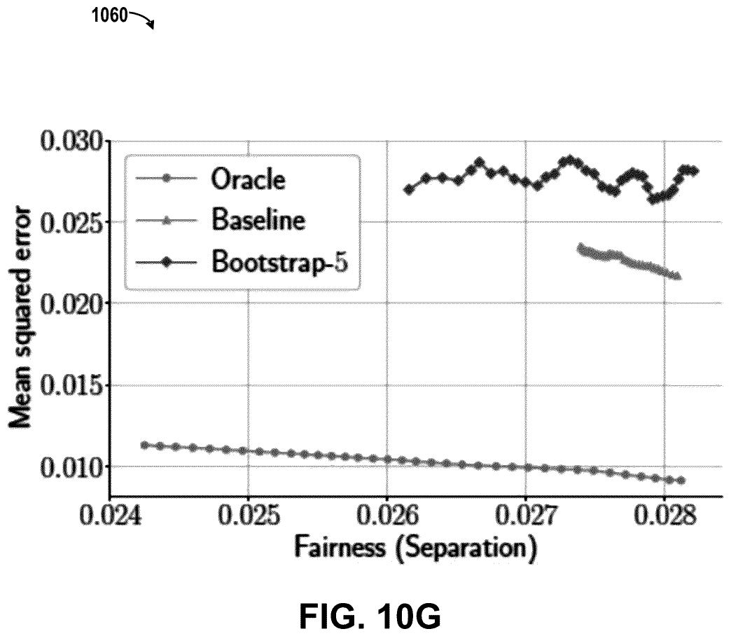

Reference is now made to FIG. 10A, which is a diagram of an exemplary table 1000 presenting an overview of multiple datasets, consistent with an illustrative embodiment. Bootstrap-S 565, in this embodiment, is tested on real-world classification and regression tasks for group constraint notions of independence and separation using three datasets: Dataset 1 (including Attribute 1), Dataset 2 (including Attribute 2), and Dataset 3 (including Attribute 3). In regards to FIG. 10A, in various embodiments, different datasets and different attributes can be used in relation to each dataset. By way of example only and not by way of limitation, Dataset 1 could be adult and Attribute 1 could be sex (binary); Dataset 2 could be crime and Attribute 2 could be race (continuous); and Dataset 3 could be insurance and Attribute 3 could be sex (binary).

In FIGS. 10B-10G, diagrams of exemplary graphs 1010,1020,1030,1040,1050,1060 for the three datasets found in FIG. 10A are presented. For FIGS. 10B, 10D, and 10F, the performance of Bootstrap-S 565 and the Baseline method 560, in relation to independence, are presented. For FIGS. 10C, 10E, and 10G, the performance of Bootstrap-S 565 and the Baseline method 560, in relation to separation, are presented. For all datasets in these embodiments, a two-layered neural network is trained. The log loss is utilized for classification, while the MSE is utilized for regression. An χ²-divergence is utilized to impose the independence (conditional independence) for independence (separation). For continuous sensitive attributes, uncertainty is induced in every sensitive attribute by adding independent N(0, σ²) noise (σ=0.5 for Dataset 2). For binary sensitive attributes, uncertainty is induced by keeping only n out of N sensitive attributes (n=100 for Dataset 1 and n=10 for Dataset 3). For Bootstrap-S, S=5 for all three datasets. Given a fairness target ϵ, a model is trained over 50 independent trials of random missingness (for Dataset 1 and Dataset 3) or random noise (for Dataset 2), and the average performance is reported (note: error bars are too small to see). Overall, over 500 different ϵ are swept from 0.001 to 0.5, and the prediction-sensitive attribute inclusion trade-off frontier is plotted by using a simple moving average over five entries.

In relation to evaluation metrics, in embodiments, predictive power is presented using error rate (lower is better) for classification and MSE (lower is better) for regression. In further embodiments, (a) independence (lower is better) is evaluated using demographic parity, i.e., |P(\hat{ }y|e=1)−P(\hat{ }y|e=0)| for classification and χ²-divergence for regression; (b) separation (lower is better) is evaluated using equal opportunity, i.e., |P(\hat{ }y|e=1, y=1)−P(\hat{ }y|e=0, y=1)| for classification and χ2-divergence for regression.

As further shown in FIGS. 10B-10G, Bootstrap-S 565 is compared with the Baseline method 560, which does not include the additional constraints of Bootstrap-S 565 (i.e., it solves for Equation 6 with λ₁, . . . . λ_{S} fixed to 0). For reference, Bootstrap-S 565 is also compared with the Oracle method 555, which has access to all of the true sensitive attributes. Relative to the results, the Baseline method 560 and Bootstrap-S 565 exhibit a concentration of sensitive attribute inclusion levels near the extreme values of ϵ, where Bootstrap-S 565 is more noisy than the Baseline method 560. However, Bootstrap-S 565 achieves significantly smaller sensitive attribute inclusion levels when compared to the Baseline method 560. It is noted that in most cases, Bootstrap-S 565 achieves sensitive attribute inclusion levels that are comparable to the Oracle method 555, while also maintaining a relatively high level of predictive power.

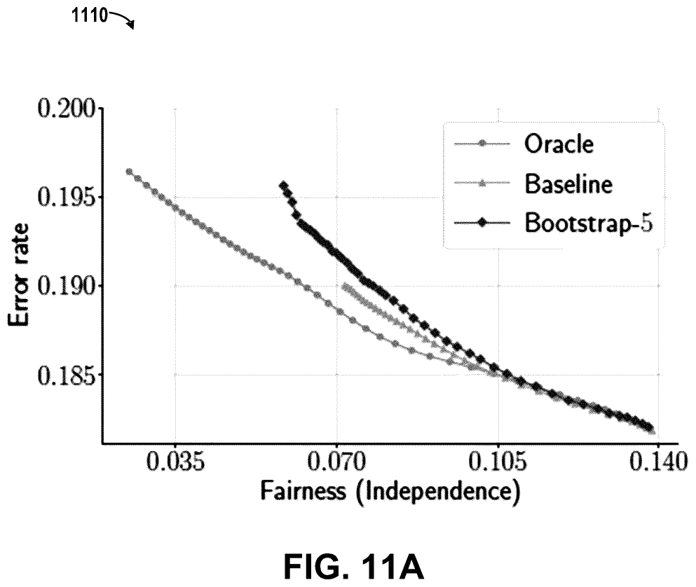

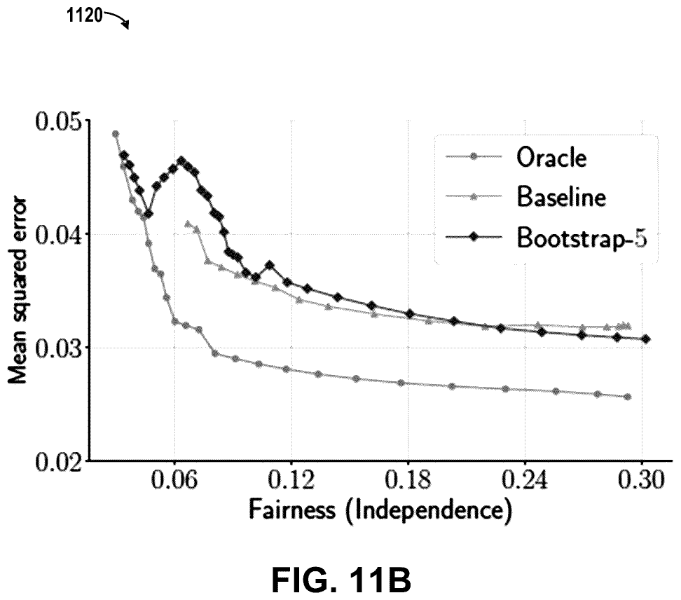

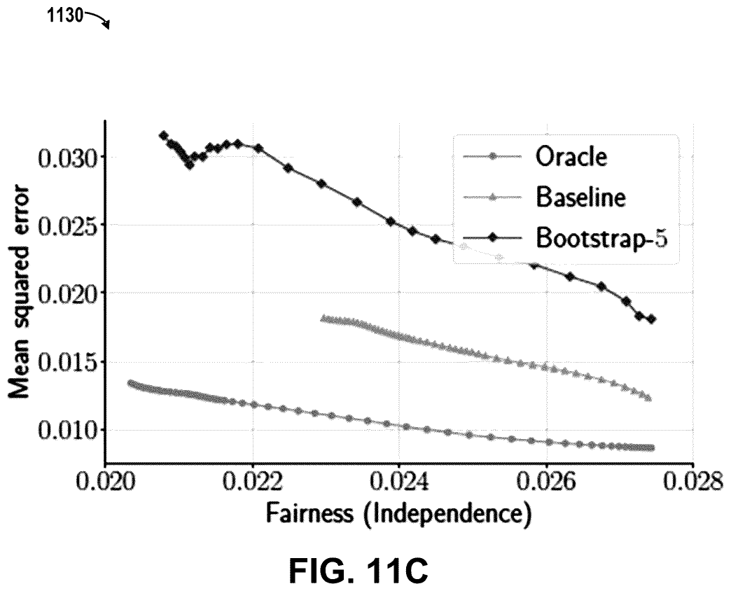

Reference is now made to FIGS. 11A-11C, which are diagrams of exemplary graphs 1110,1120,1130 of error rate and means squared error for models trained with Dataset 1, Dataset 2, and Dataset 3 of FIG. 10A, consistent with an illustrative embodiment. As shown, results for independence notions of sensitive attribute inclusion with n=200 for Dataset 1, σ=0.25 for Dataset 2, and n=20 for Dataset 3, respectively, where n denotes the number of sensitive attributes kept out of N and σ decides the amount of noise added to the sensitive attributes. The observations are consistent with those found in FIGS. 10B, 10D, and 10F. Additionally, Bootstrap-S 565 achieves much better sensitive attribute inclusion levels compared to the Baseline method 560 throughout.

With the foregoing overview of the example architecture/environment/computing system 100, 400, it may be helpful to consider a high-level discussion of an example process. To that end FIG. 12 presents a flowchart 1200 for generating a sensitive attribute driven predictive model, consistent with an illustrative embodiment.

Flowchart 1200 is illustrated as a process in logical flowchart format, wherein the flowchart represents a sequence of operations that can be implemented in hardware, software, or a combination thereof. In the context of software, the process represents computer-executable instructions that, when executed by one or more processors, perform the recited operations. Generally, computer-executable instructions may include routines, programs, objects, components, data structures, and the like that perform functions or implement abstract data types. The order in which the operations are described is not intended to be construed as a limitation, and any number of the described processes can be combined in any order and/or performed in parallel to implement the process. For discussion purposes, the computer-implemented method for generating a predictive model is described with reference to the architecture of environment 100 and system 400 of FIGS. 1 and 4.

At block 1210, a computation engine 410 learns a predictive model having missing or crippled data.

At block 1220, a processor 420 applies a formulated problem of missing or crippled data based learning to the predictive model.

At block 1230, a computation engine 410 reduces one or more tasks associated with the predictive model to a quadratically constrained quadratic problem (QCQP).

At block 1240, a computation engine 410 characterizes one or more solutions associated with the QCQP, where each of the one or more solutions is a loss function value. The method is advantageous in that the predictive models are capable of following strict constraints without any performance loss, leading to more accurate and less biased predictive models.

In one embodiment, the missing or crippled data is related to one or more sensitive attributes.

In a further embodiment, the formulated problem is based on an independence of sensitive attribute criterion. By virtue of this feature, a predictive model can achieve a target level of sensitive attribute inclusion despite uncertainty in sensitive attributes.

In a further embodiment, each of the one or more tasks comprise: a classification task or a regression task. By virtue of this feature, a more generally applicable predictive model is provided.

In a further embodiment, the integration workflow of flowchart 1200 further includes further includes, in response to uncertainty from a limited amount of labeled data, identifying a contribution of each of the one or more solutions towards an improved (e.g., optimal) performance of the QCQP achieved with unlimited access to labeled sensitive attributes. By virtue of this feature, a more accurate and less biased predictive model is provided.

In a further embodiment, the identifying further comprises identifying non-trivial regimes where uncertainty incurs no performance loss associated with the predictive model and embodies a strict sensitive attribute inclusion.

In a further embodiment, a generic bootstrap-based algorithm is utilized by the predictive model for non-Gaussian data. This may have the technical effect of reducing computing resources used by one or more components within the system.

For the purposes of this disclosure, sensitive attributes are considered uncertain due to at least one of: a limited amount of labeled data, a collection bias, or a privacy mechanism.

For the purposes of this disclosure, a “sensitive attribute” can be an attribute associated with inanimate objects and concepts (as well as human individuals).

Importantly, although the operational/functional descriptions described herein may be understandable by the human mind, they are not abstract ideas of the operations/functions divorced from computational implementation of those operations/functions. Rather, the operations/functions represent a specification for an appropriately configured computing device. As discussed in detail below, the operational/functional language is to be read in its proper technological context, i.e., as concrete specifications for physical implementations.

Accordingly, one or more of the methodologies discussed herein may obviate a need for time consuming data processing by the user. This may have the technical effect of reducing computing resources used by one or more components within the system. Additionally, one or more of the methodologies discussed herein may obviate a need for biased predictive models in relation to sensitive attribute inclusion. This may have the technical effect of increasing the accuracy of predictive models (leading to more accurate forecasting) and also reducing computing resources used by one more components within the system. Examples of such computing resources include, without limitation, processor cycles, network traffic, memory usage, storage space, and power consumption.

It should be appreciated that aspects of the teachings herein are beyond the capability of a human mind. It should also be appreciated that the various embodiments of the subject disclosure described herein can include information that is impossible to obtain manually by an entity, such as a human user. For example, the type, amount, and/or variety of information included in performing the process discussed herein can be more complex than information that could be reasonably be processed manually by a human user.

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to call flow illustrations and/or block diagrams of a method, apparatus (systems), and computer program products according to embodiments of the present disclosure. It will be understood that each step of the flowchart illustrations and/or block diagrams, and combinations of blocks in the call flow illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the call flow process and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the call flow and/or block diagram block or blocks.

The computer readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the call flow process and/or block diagram block or blocks.

The flowchart and block diagrams in the Figures illustrate the architecture, functionality, and operation of possible implementations of systems, methods, and computer program products according to various embodiments of the present disclosure. In this regard, each block in the call flow process or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or call flow illustration, and combinations of blocks in the block diagrams and/or call flow illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method for generating a predictive model using a computation engine and a processor; the method comprising:
learning, by the computation engine, the predictive model having missing or crippled data;
applying, via the processor, a formulated problem of missing or crippled data based learning to the predictive model;
reducing, by the computation engine, one or more tasks associated with the predictive model to a quadratically constrained quadratic problem (QCQP); and
characterizing, via the computation engine, one or more solutions associated with the QCQP, wherein each of the one or more solutions is a loss function value.

2. The method of claim 1, wherein the missing or crippled data is related to one or more sensitive attributes.

3. The method of claim 2, wherein the formulated problem is based on an independence of sensitive attribute criterion.

4. The method of claim 1, wherein each of the one or more tasks comprise: a classification task or a regression task.

5. The method of claim 1, further comprising, in response to uncertainty from a limited amount of labeled data, identifying a contribution of each of the one or more solutions towards an improved performance of the QCQP achieved with unlimited access to labeled sensitive attributes.

6. The method of claim 5, wherein the identifying further comprises identifying non-trivial regimes where uncertainty incurs no performance loss associated with the predictive model and embodies a strict sensitive attribute inclusion.

7. The method of claim 1, wherein a generic bootstrap-based algorithm is utilized by the predictive model for non-Gaussian data.

8. A computer program product for generating a predictive model, the computer program product comprising a computer readable storage medium having program instructions embodied therewith, the program instructions executable by a processor to cause the processor to perform:
learning, by a computation engine, the predictive model having missing or crippled data;
applying, via the processor, a formulated problem of missing or crippled data based learning to the predictive model;
reducing, by the computation engine, one or more tasks associated with the predictive model to a quadratically constrained quadratic problem (QCQP); and
characterizing, via the computation engine, one or more solutions associated with the QCQP, wherein each of the one or more solutions is a loss function value.

9. The computer program product of claim 8, wherein the missing or crippled data is related to one or more sensitive attributes.

10. The computer program product of claim 9, wherein the formulated problem is based on an independence of sensitive attribute criterion.

11. The computer program product of claim 8, wherein each of the one or more tasks comprise: a classification task or a regression task.

12. The computer program product of claim 8, further comprising, in response to uncertainty from a limited amount of labeled data, identifying a contribution of each of the one or more solutions towards an improved performance of the QCQP achieved with unlimited access to labeled sensitive attributes.

13. The computer program product of claim 12, wherein the identifying further comprises identifying non-trivial regimes where uncertainty incurs no performance loss associated with the predictive model and embodies a strict sensitive attribute inclusion.

14. A computing system comprising:
a processor;
a computer-readable storage device coupled to the processor;
a computation engine coupled to the processor;
program instructions stored on the computer-readable storage device for execution by the processor via a memory, wherein execution of the program instructions by the processor configures the processor to perform a predictive model generating method comprising:
learning, by the computation engine, a predictive model having missing or crippled data;
applying, via the processor, a formulated problem of missing or crippled data based learning to the predictive model;
reducing, by the computation engine, one or more tasks associated with the predictive model to a quadratically constrained quadratic problem (QCQP); and
characterizing, via the computation engine, one or more solutions associated with the QCQP, wherein each of the one or more solutions is a loss function value.

15. The computing system of claim 14, wherein the missing or crippled data is related to one or more sensitive attributes.

16. The computing system of claim 15, wherein the formulated problem is based on an independence of sensitive attribute criterion.

17. The computing system of claim 14, wherein each of the one or more tasks comprise: a classification task or a regression task.

18. The computing system of claim 14, further comprising, in response to uncertainty from a limited amount of labeled data, identifying a contribution of each of the one or more solutions towards an improved performance of the QCQP achieved with unlimited access to labeled sensitive attributes.

19. The computing system of claim 18, wherein the identifying further comprises identifying non-trivial regimes where uncertainty incurs no performance loss associated with the predictive model and embodies a strict sensitive attribute inclusion.

20. The computing system of claim 14, wherein a generic bootstrap-based algorithm is utilized by the predictive model for non-Gaussian data.
